(19) United States
(12) Patent Application Publication
(10) Pub. No.: US 2014/0167608 A1
(43) Pub. Date: Jun. 19, 2014

(54) METHOD FOR DETERMINING A LIGHTING RANGE OF A HEADLIGHT

(71) Applicant: Dr. Ing. h.c. F. Porsche Aktiengesellschaft, Stuttgart (DE)

(72) Inventor: Dejan Djordjevic, Stuttgart (DE)

(73) Assignee: Dr. Ing. h.c. F. Porsche Aktiengesellschaft, Stuttgart (DE)

(21) Appl. No.: 14/078,560

(22) Filed: Nov. 13, 2013

(30) Foreign Application Priority Data
Dec. 18, 2012 (DE) 1020121 12478.7

(51) Int. Cl. B60Q 1/14

(52) U.S. Cl. CPC B60Q 1/143
USPC 315/79

(57) ABSTRACT

A method for determining a lighting range of a headlight of a vehicle includes determining the lighting range for the vehicle as a function of a position of a second vehicle driving ahead of the vehicle in the direction of travel. The method includes checking whether a braking process of the vehicle is occurring, and when a braking process is detected, reducing the determined lighting range by a correction value.

### CROSS REFERENCE TO RELATED APPLICATIONS

This application claims priority from German Patent Application No. DE 10 2012 112 478.7, filed Dec. 18, 2012, which is hereby incorporated by reference herein in its entirety.

### FIELD

The invention relates to a method for determining a lighting range of a headlight, and to a computing unit for carrying out the method.

### BACKGROUND

The prior-art document DE 10 2008 031 947 A1 discloses a method for determining a lighting range setting of a vehicle. The method comprises determining a position of the vehicle with respect to its surroundings and determining a lighting range setting by means of the determined position of the vehicle. In addition, an adjustment time which is required to carry out automatic lighting range adjustment on the vehicle to the determined lighting range setting is determined, and a change in position of the vehicle during the adjustment time is predicted. By logically linking the lighting range setting determined on the basis of the position of the vehicle and the change in position of the vehicle predicted during the adjustment time a corrected lighting range setting is determined

### SUMMARY

In an embodiment, the present invention provides a method for determining a lighting range of a headlight of a vehicle includes determining the lighting range for the vehicle as a function of a position of a second vehicle driving ahead of the vehicle in the direction of travel. The method includes checking whether a braking process of the vehicle is occurring, and when a braking process is detected, reducing the determined lighting range by a correction value.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic illustration of two vehicles on a road,

FIG. 2 shows a schematic illustration of a vehicle, and

FIG. 3 shows a schematic illustration of the method for controlling the lighting range

### DETAILED DESCRIPTION

An aspect of the invention is to make available an improved method for determining a lighting range with which good illumination of the road is made possible and at the same time a dazzling effect on other vehicles, even under extreme conditions, is reduced or avoided.

One advantage of the described method is that the front part of the vehicle the lighting range of the vehicle is corrected as a function of a braking process with a correction value. The lighting range is set to a shorter value when a braking process occurs than would be the case without a braking process. This ensures that in the case of an abrupt end of the braking process, in the case of which the front part of the vehicle and therefore the headlights tilt upward abruptly, dazzling of a second vehicle driving ahead of the vehicle is reliably avoided.

In one embodiment, the correction value depends on another parameter. As a result, the correction value can be set individually. Precise correction is therefore possible.

In another embodiment, the correction value is determined as a function of a roadway contour, in particular as a function of an altitude contour of the roadway. This method is advantageous, in particular, if a roadway depression is driven through. When a roadway depression is driven through, the lighting range of the headlight is increased compared with a normal position, in particular, as far as another vehicle driving ahead of the vehicle in the direction of travel. According to the described method, when a braking process is occurring the lighting range is again reduced by a defined correction value. As a result, during subsequent release of the brake, a sufficient overall reaction time is available in the system, with the result that the tilting movement of the front part of the vehicle in the upward direction is correspondingly compensated for after the release of the brake and the driver who is driving ahead in the direction of travel is not dazzled.

In another embodiment, the correction value is defined as a function of an inclination of the vehicle with respect to a defined normal inclination of the vehicle. The normal inclination of the vehicle is predefined, for example, by the inclination of the vehicle without a braking effect. As a result, the tilting movement at the front part of the vehicle in the upward direction, which is brought about by the release of the brake, can be estimated and taken into account in the determination of the correction value.

In another embodiment, the correction is carried out only if the vehicle is in the process of driving through a roadway depression. In the region of the roadway depression, a reduction in the lighting range is perceived by the driver as hardly disruptive at all since owing to the roadway depression a relatively large lighting range is defined.

In another embodiment, the correction value of the lighting range can be defined as a function of the speed and/or as a function of the braking deceleration and/or as a function of whether the vehicle driving ahead is driving in the direction of travel of the vehicle or in an opposite direction. In this way, optimum correction of the lighting range can be achieved without dazzling the driver of the vehicle driving ahead, in particular when a braking process is occurring.

In another embodiment, a distance and/or a position of the vehicle driving ahead is detected by means of a camera and the lighting range is defined as a function of the data of the camera. The use of a camera provides safe and reliable detection of the position of the vehicle driving ahead. The vehicle driving ahead can be a vehicle driving in the same direction or an oncoming vehicle. This information can also be taken into account in the definition of the correction value of the lighting range.

In one embodiment of the invention, the occurrence of the braking process is detected by monitoring activation of a brake pedal. As a result, rapid and reliable detection of a braking process can be achieved.

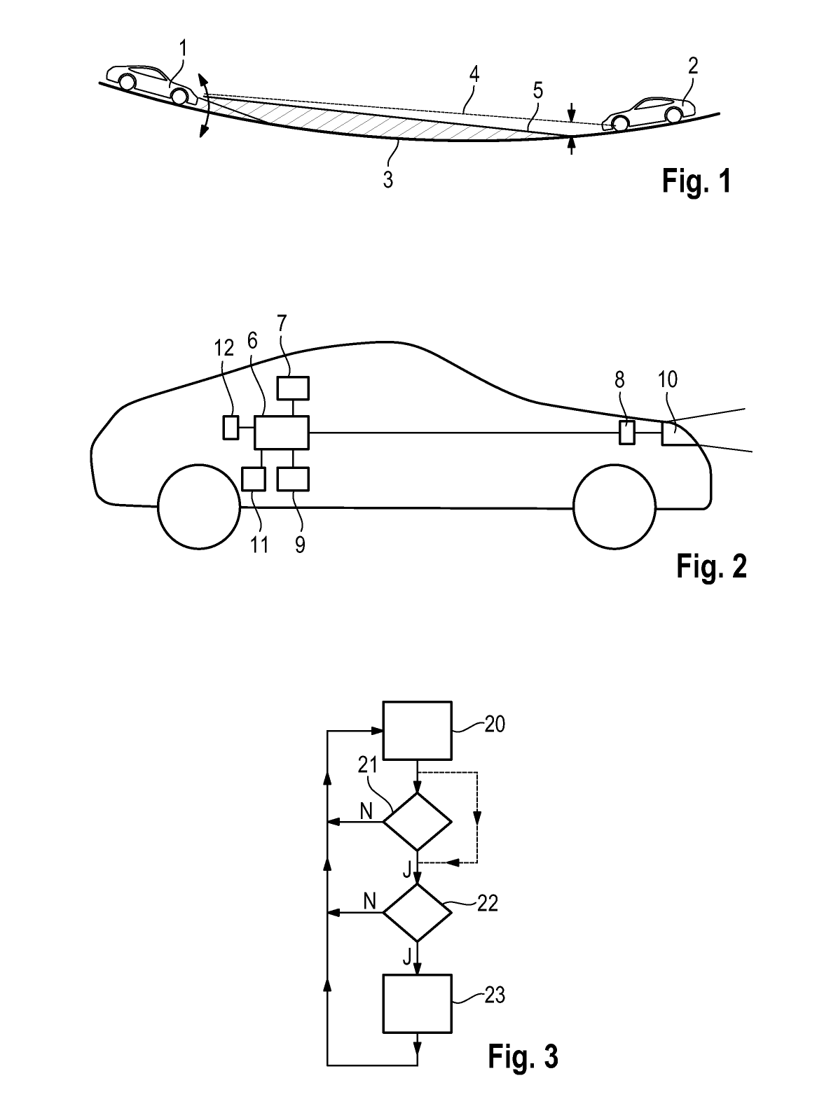

FIG. 1 shows a schematic illustration of a driving situation in which a vehicle 1 is driving on a road 3 in a direction to the right. On the road 3, the vehicle 1 faces another, oncoming vehicle 2. The vehicle 1 detects, for example, by means of a camera an altitude position of the other vehicle 2 in relation to the vehicle 1. In addition, the camera can detect whether the other vehicle 2 is driving in the same direction or in the opposite direction to the vehicle 1. The camera transmits the information to a computing unit which determines a lighting range for the vehicle 1 on the basis of the position of the other vehicle with respect to the vehicle 1, and preferably on the basis of the direction of travel of the other vehicle 2, which lighting range preferably extends as far as the other vehicle 2 without dazzling a driver of the other vehicle 2. When the relative altitude position changes and/or there are changes in the distance between the other vehicle 2 and the vehicle 1, the lighting range of the vehicle 1 is also adapted as far as the other vehicle 2, i.e. a sliding lighting range adjustment is carried out.

Particular driving situations such as, for example, braking of the vehicle 1, cause the lighting range to be simultaneously reduced owing to the lowering of a front part of the vehicle 1 when braking. The lowering of the front part of the vehicle would be detected by the computing unit and compensated for in that the lighting range is maintained, i.e. the inclination of the headlight is tilted in the upward direction. Contrary to this procedure, it is now proposed that when a braking process is detected the lowering of the front part of the vehicle will not be compensated for by the lighting range adjustment, or at least will not be compensated for completely. This situation is illustrated schematically in FIG. 1 in such a way that according to the sliding lighting range adjustment during the braking of the vehicle 1 the lighting range is compensated for in the upward direction as far as an upper edge 4, with the result that the region which is illuminated extends as far as the other vehicle 2.

According to the new procedure, when a braking process is detected, the sliding lighting range adjustment is corrected with a correction value and a relatively small second height 5 is set for the illumination. As a result, the area which is completely available up to the other vehicle 2 is not illuminated. However, this avoids the driver of the other vehicle 2 being dazzled when the brake is released and thus the front part of the vehicle 1 tilts upward abruptly, since the headlights of the vehicle 1 also tilt upward without the lighting range adjustment being capable, owing to the delayed reaction, of compensating for the tilting in the upward direction. The reduction in the lighting range when the brake of the vehicle 1 is released avoids the driver of the other vehicle 2 being dazzled as a result of the abrupt upward tilting of the front part of the vehicle 1. Owing to the lag times which are present, caused by signal measurement and/or signal transmission and/or signal processing and corresponding actuation and adjustment of the drive of the headlights, the computing unit can not compensate for abrupt upward tilting of the vehicle by means of the sliding lighting range adjustment after the release of the brake. As a result, in order to prevent incorrect illumination and dazzling of the other vehicle 2, the lighting range is preventively reduced by a parameterizable correction value. In particular, this method can be taken into account in the event of driving through a depression, i.e. a roadway which is shaped concavely in an altitude contour. If it is detected, for example, by means of an inclination sensor or by means of prior information such as, for example, map information, that the vehicle 1 is in the process of driving through a roadway depression, the execution of the new method can be enabled by the computing unit. If the computing unit then detects that a braking process is occurring, for example by monitoring the brake pedal or by monitoring an acceleration sensor, the computing unit carries out the described method and corrects the setting of the headlights determined by the sliding lighting range adjustment. The correction value can depend on other parameters. For example, one parameter can be the distance between the two vehicles 1, 2, the speed of the vehicle 1 and/or the speed of the other vehicle 2 or a direction of travel of the other vehicle. In order to take into account the parameters, tables, characteristic curves and/or calculation methods are stored.

The described method can also be applied on a straight route or when driving over a crest of a hill. A roadway depression provides a geometric advantage which means that somewhat reduced illumination in a depression hardly impairs the visibility of the driver of the vehicle 1 at all since good illumination is present in any case in the depression, in particular the lighting range extends over a low point of the depression. Even after a correction of the lighting range, better illumination is achieved than with a normal range of the dipped headlight.

FIG. 2 shows a schematic illustration of components of the vehicle 1. The vehicle 1 has a computing unit 6 which is connected to a camera 7. The computing unit 6 can set the orientation of the headlights 10 and therefore the lighting range by actuating the drive 8. In addition, the computing unit 6 is connected to a drive 8 of a headlight 10. Furthermore, the computing unit 6 is connected to a sensor 9 with which, for example, activation of a brake pedal is detected. In addition, the computing unit 6 is connected to further sensors 11 which are embodied, for example, as an acceleration sensor and/or as an inclination sensor. The computing unit can detect a braking process by means of the sensor 9. In addition, the computing unit 6 can detect by means of the further sensors 11 whether the vehicle is driving through a roadway depression.

For example, a roadway depression can be detected if the front part of the vehicle has been lowered by five degrees compared to a horizontal position without deceleration, that is to say a braking process, occurring.

In addition, the computing unit 6 can also detect a braking process on the basis of a negative acceleration by means of the further sensors 11. Furthermore, the computing unit 6 can detect, by means of the inclination sensors, downward tilting of the front part of the vehicle caused by a braking process. As a result, the computing unit 6 can take into account, during the detection of the correction value, for example the size of the angle when the front part of the vehicle tilts, which is caused by the braking process.

In addition, the computing unit 6 is connected to a navigation device 12 which has map information. As a result, the computing unit 6 can detect, on the basis of the position of the vehicle, which is determined, for example, by means of a GPS system, and on the basis of the map information, whether the vehicle 1 is in the process of driving through a roadway depression. By means of the further sensors 11, the speed of the vehicle 1 can also be detected. As a result, the computing unit can also take into account the speed of the vehicle 1 for determining the correction value and/or adapting the correction value.

FIG. 3 shows a schematic illustration of a sequence of the described method. In this case, at program point 20 a lighting range adjustment for the lighting range of the headlights of the vehicle is carried out by the computing unit 6 which is located in the vehicle 1. In this context, the computing unit 6 takes into account, for example, information of the camera 7 relating to the position of another vehicle 2 which is driving ahead of the vehicle 1. In addition, the computing unit 6 takes into account, for the determination of the lighting range, the inclination of the vehicle 1 which is detected, for example, with the further sensors 11. Furthermore, the computing unit 6 can also take into account information about the surroundings, in particular an altitude contour of the roadway, which is made available, for example, by map data of the navigation device. A lighting range for the vehicle 1 is determined by the computing unit 6 as a function of at least one of the described parameters. The lighting range is generally determined as close as possible to the other vehicle 2 driving ahead, with the result that the road is illuminated as well as possible for the driver of the vehicle and in addition the driver of the other vehicle is not dazzled.

At a following program point 21, which is, however, only carried out optionally, the computing unit can check whether the vehicle is driving through a roadway depression. This may be detected, for example, by means of an inclination sensor or by means of a position of the vehicle and map information. If the checking at program point 21 reveals that a roadway depression is not being driven through, the system branches back to program point 20. If the interrogation at program point 21 reveals that the vehicle is driving through a roadway depression, the system subsequently branches to program point 22. As already described, the new method is suitable, in particular, for driving through a roadway depression, but it can also be applied for other roadway contours. The interrogation at program point 21 is therefore only optional. In the embodiment in which program point 21 is not provided, the system branches from program point 20 directly to program point 22.

At program point 22, the computing unit 6 checks whether a braking process is occurring. If a braking process is not occurring, the system branches back to program point 20. However, if the computing unit 6 detects, for example by interrogating a sensor for detecting activation of the brake pedal or by interrogating an acceleration sensor, that a braking process is occurring, a correction value, by which the lighting range determined by the sliding lighting range adjustment is reduced, is predefined by the computing unit 6 at a following program point 23. The correction value can have a defined value depending on the selected embodiment. In addition, the correction value can, however, also depend on other parameters such as, for example, the distance between the two vehicles, the direction of travel of the other vehicle, the relative speed of the two vehicles with respect to one another, a value of the negative acceleration of the braking process and/or an inclination, i.e. tilting of the front part of the vehicle, caused by the braking process.

The computing unit subtracts the correction value from the value of the lighting range adjustment and transmits the corrected value for the lighting range to the drive of the headlight of the vehicle 1. The lighting range is therefore reduced by the correction value if a braking process is occurring. The system then branches back to program point 20.

Depending on the selected embodiment, the lighting range adjustment is carried out by a program of the computing unit 6. The correction value is determined by a second program, by means of a simple interrogation as to whether braking is occurring. The correction value can therefore be calculated and taken into account quickly and easily.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for determining a lighting range of a headlight of a vehicle, the method comprising:
determining the lighting range for the vehicle as a function of a position of a second vehicle driving ahead of the vehicle in the direction of travel,
checking whether a braking process of the vehicle is occurring, and
reducing, when a braking process is detected, the determined lighting range by a correction value.

2. The method as recited in claim 1, wherein the correction value is dependent on another parameter.

3. The method as recited in claim 2, wherein the correction value depends on a roadway contour.

4. The method as recited in claim 3, wherein the correction value depends a roadway depression through which the vehicle drives.

5. The method as recited in claim 2, wherein the correction value depends on an inclination of the vehicle with respect to a normal inclination of the vehicle.

6. The method as recited in claim 2, wherein the correction value depends on a value of a negative acceleration of the vehicle during the braking process.

7. The method as recited in claim 2, wherein the correction value depends on a relative speed of the vehicle and the second vehicle with respect to one another.

8. The method as recited in claim 2, wherein the correction value depends on a direction of travel of the second vehicle.

9. The method as recited in claim 1, wherein the correction is carried out only if the vehicle drives through a roadway depression.

10. The method as recited in claim 1, wherein a position of the second vehicle is detected using a camera.

11. The method as recited in claim 10, wherein a relative altitude position of the second vehicle with respect to the vehicle is detected using the camera.

12. The method as recited in claim 1, wherein the braking process is detected by monitoring activation of a brake pedal.

13. A computing unit configured to carry out a method, the method comprising:
determining the lighting range for the vehicle as a function of a position of a second vehicle driving ahead of the vehicle in the direction of travel,
checking whether a braking process of the vehicle is occurring, and
reducing, when a braking process is detected, the determined lighting range by a correction value.
